(19) United States
(12) Patent Application Publication
(10) Pub. No.: US 2024/0330535 A1
(43) Pub. Date: Oct. 3, 2024

(54) LOGICAL AND STATISTICAL COMPOSITE MODELS

(71) Applicant: International Business Machines Corporation, Armonk, NY (US)

(72) Inventors: Lior Horesh, North Salem, NY (US); Bachir El Khadir, White Plains, NY (US); Sanjeeb Dash, Croton on Hudson, NY (US); Kenneth Lee Clarkson, Madison, NJ (US); Cristina Cornelio, White Plains, NY (US)

(21) Appl. No.: 18/190,239

(22) Filed: Mar. 27, 2023

(51) Int. Cl. G06F 30/20

(52) U.S. Cl. CPC G06F 30/20; G06F 2111/02; G06F 2111/06

(57) ABSTRACT

Embodiments of the invention are directed to a programmable computer system having a processor system operable to perform processor system operations that include representing a set of candidate functions in a mathematical expression domain. The set of candidate functions defines relationships between data of an existing system. A set of known background theory is represented in the mathematical expression domain. The set of known background theory defines known relationships associated with the existing system. A model composition operation is performed that includes analyzing, in the mathematical expression domain, the set of candidate functions and the set of known background theory to generate a composed model that satisfies a target data fidelity in a manner that also satisfies a predetermined level of compatibility between the composed model and the set of known background theory.

### STATEMENT REGARDING FEDERALLY SPONSORED RESEARCH OR DEVELOPMENT

This invention was made with Government support under Contract No.: FA8750-18-C-0098 P00003 awarded by the Defense Advanced Research Projects Agency (DARPA). The Government has certain rights to this invention.

### BACKGROUND

The present invention relates in general to programmable computer systems that are configured to model existing systems or processes. More specifically, the present invention relates to computing systems, computer-implemented methods, and computer program products operable to compose a novel logical & statistical (L&S) composite model of an existing system or process using novel L&S model composition techniques that are operable to concurrently perform two complementary forms of inference-namely, logical (e.g., symbolic) inferences and statistical (e.g., numerical) inferences. In some embodiments of the invention, the novel L&S model composition techniques satisfy target data fidelity levels and are compatible with known background theory associated with the existing system.

In general, a mathematical model represents an existing system or a process in another form (e.g., a computer algorithm) that can virtually reproduce the relationships between important elements of the existing system. A mathematical model need not describe all aspects of the existing system or process, but it should represent enough of the important elements and their interrelationships to describe the essential nature of the existing system. In scientific studies and analysis, it is beneficial to work with an artificial or virtual instance of an existing system in the form of a mathematical model, which can be manipulated in a manner that mimics or simulates the behavior of the actual existing system. Performing scientific research, studies, and analysis on mathematical models of an existing system instead of the system itself is particularly useful where performing such research, studies or analysis on the existing system is impractical, risky, or not cost-effective.

Mathematical models can take a variety of forms, including, for example symbolic models. Symbolic models represent systems in terms of the way they function, often through time and over space. Symbolic models involve the use of mathematical symbols, letters, numbers and operators (+, −, ×, exp, log) to represent relationships among various variables of the system to describe the system's properties or behavior.

Known methods for automatically generating mathematical models can be divided in two broad categories. The first category includes data-driven analysis techniques (e.g., symbolic regression methods and deep learning methods) that attempt to generate a mathematical model of a to-be-modeled system (TBM-system) using only numerical data of the TBM-system. The second category includes logic-based analysis techniques (e.g., automatic theorem provers) that reason over mathematically derivable formulas from a given set of axioms and background theory (e.g., conservation of energy, conservation of mass, conservation of angular momentum as promulgated by theoretical physicists, etc.). Such logic-based techniques are indifferent to the presence or absence of numerical data and do not tolerate noise in their input.

It is a challenge to compose well-functioning mathematical models of existing systems. So-called “data-driven” techniques for composing models generally lack interpretability in that the model performs its tasks using various weights and biases that are uncovered through training, but the weights and biases do not convey a meaningful sense of the underlying relationships. Additionally, there are no rigorous theoretical guarantees of how such models will generalize across a range of data, including specifically data that falls outside the data that was used to train the model. Furthermore, these data-driven model composition techniques often require large amount of data, and are not guaranteed to converge. Logic-based model composition techniques generally use only symbolic relations rather than numerical values to assess the validity of certain logical statements; do not perform well when either an incomplete or partially incorrect set of axioms or background theory is employed; are computationally intractable; approximate representation of logical expressions via neural networks; require large amount of data; are not guaranteed to converge; and cannot generally handle function symbols.

### SUMMARY

Embodiments of the invention are directed to a programmable computer system having a processor system operable to perform processor system operations that include representing a set of candidate functions in a mathematical expression domain. The set of candidate functions defines relationships between data of an existing system. A set of known background theory is represented in the mathematical expression domain. The set of known background theory defines known relationships associated with the existing system. A model composition operation is performed that includes analyzing, in the mathematical expression domain, the set of candidate functions and the set of known background theory to generate a composed model that satisfies a target data fidelity in a manner that also satisfies a predetermined level of compatibility between the composed model and the set of known background theory.

The above-described features of the programmable computer system provide technical effects and benefits by providing a mechanism for composing well-functioning mathematical models of existing systems by effectively composing a model that satisfies both data fidelity targets and target compatibility levels between the composed model and known background theory of the existing system. In this detailed description, such models are referred to as logical & statistical (L&S) models (or L&S composite models), and the mechanisms to compose L&S models are referred to as L&S symbolic model composition techniques or L&S model composition mechanisms. The L&S model composition mechanisms can include placing both the candidate functions and the known background theory in the same mathematical expression domain, which facilitates analyzing target goals for the candidate functions and target goals for the known background theory such that both sets of target goals can be satisfied substantially concurrently, thereby facilitating the generation of the composed L&S model that satisfies a target data fidelity in a manner that also satisfies a predetermined level of compatibility between the composed L&S model and the set of known background theory.

In addition to one or more of the features described above, or as an alternative to any of the foregoing embodiments, the mathematical expression domain is selected based at least in part on an expressive capability of the mathematical expression domain; and the expressive capability of the mathematical expression domain includes a breadth of the candidate functions that can be represented in the mathematical expression domain.

The above-described features of the programmable computer system provide technical effects and benefits over known model composition approaches in that selecting the mathematical expression domain based on its expressive capability allows selection of a mathematical expression domain having the ability to approximate a large family of functions, which allows the L&S model composition operation to generate a wide range of composed L&S models.

In embodiments of the invention, the mathematical expression domain is a polynomial mathematical expression.

The above-described features of the programmable computer system provide technical effects and benefits over known model composition approaches in that selecting the mathematical expression domain to be a polynomial mathematical expression (or a polynomial function) provides the capability of searching over mathematical models that are derivable from a set of polynomial equalities and inequalities can be turned into a search for so-called polynomial multipliers that can advantageously be carried out using semidefinite programming. Additionally, providing the mathematical expression domain as polynomial functions provides the previously-described ability to approximate a large family of functions, which allows the L&S model composition operations to generate a wide range of composed L&S models.

In addition to one or more of the features described above, or as an alternative to any of the foregoing embodiments, performing the model composition operations further includes providing the mathematical expression domain as a polynomial mathematical expression (or a polynomial function) and analyzing, in the polynomial function domain, the set of candidate functions and the set of known background theory to generate a proof of correctness of the composed model.

The above-described features of the programmable computer system provide technical effects and benefits over known model composition approaches in that, as a general proposition, the more expressive a model or function is, the more difficult it will be to prove the theorems contained in the model or function, and to solve optimization problems in model or function. The use of polynomial functions with equalities, or with inequalities, provides an extremely expressive mathematical domain for conducting the L&S model composition operations using efficient techniques (e.g., semidefinite problem-solving techniques) that efficiently work with polynomial functions while also offering functionality that generates a proof of correctness of the resulting composed L&S model.

In addition to one or more of the features described above, or as an alternative to any of the foregoing embodiments, performing the model composition operation further includes analyzing, in the mathematical expression domain, the set of candidate functions and the set of known background theory to generate the composed model such that the composed model satisfies the target data fidelity in a manner that also satisfies a target complexity level of the composed model.

The above-described features of the programmable computer system provide technical effects and benefits over known model composition approaches in that the target complexity level can be selected such that the complexity of the composed L&S model is minimized, thereby improving efficiency of the L&S model composition operation.

In addition to one or more of the features described above, or as an alternative to any of the foregoing embodiments, performing the L&S model composition operation further includes analyzing, in the mathematical expression domain, the set of candidate functions and the set of known background theory to generate the composed model in a manner that applies a first weighted user preference to the target data fidelity; a second weighted user preference to the predetermined level of compatibility between the composed model and the set of known background theory; and a target complexity level of the composed model.

The above-described features of the programmable computer system provide technical effects and benefits over known model composition approaches in that the L&S model composition operation can be performed in a manner that allows a user to tailor the model composition operation to provide more or less emphasis on the target data fidelity; the predetermined level of compatibility between the composed L&S model and the set of known background theory; and the target complexity level of the composed L&S model.

Embodiments of the invention are also directed to computer-implemented methods and computer program products having substantially the same features and technical benefits and effects as the programmable computer system described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a block diagram illustrating a system according to embodiments of the invention;

FIG. 2 depicts a block diagram illustrating exemplary to-be-modeled systems that can be modeled using embodiments of the invention;

FIG. 3 depicts a block diagram illustrating an example implementation of a novel logical & statistical (L&S) symbolic model composer according to embodiments of the invention;

FIG. 4 depicts a block diagram functional relationships that are leveraged in a system according to embodiments of the invention;

FIG. 5 depicts a flow diagram illustrating a computer-implemented method according to embodiments of the invention;

FIG. 6A depicts an example of how an L&S symbolic mathematical model can be generated in accordance with embodiments of the invention;

FIG. 6B depicts an example of how an L&S symbolic mathematical model can be generated in accordance with embodiments of the invention;

FIG. 7 depicts an example of how an L&S symbolic mathematical model can be generated in accordance with embodiments of the invention;

FIG. 8 depicts an example of how an L&S symbolic mathematical model can be generated in accordance with embodiments of the invention;

FIG. 9 depicts an example of how an L&S symbolic mathematical model can be generated in accordance with embodiments of the invention;

FIG. 10 depicts an example of how an L&S symbolic mathematical model can be generated in accordance with embodiments of the invention;

FIG. 11 depicts an example of how an L&S symbolic mathematical model can be generated in accordance with embodiments of the invention; and

FIG. 12 depicts details of an exemplary computing environment operable to implement various aspects of the invention.

In the accompanying figures and following detailed description of the disclosed embodiments, the various elements illustrated in the figures are provided with three digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

Many of the functional units of the systems described in this specification have been labeled as models. In embodiments of the invention, such models can be mathematical models that represent an existing system in another form (e.g., a computer algorithm) that can virtually reproduce the relationships between important elements of the existing system. In embodiments of the invention, the existing system or process includes a phenomena-under-analysis (PUA) (and/or a phenomena under study/consideration). The mathematical model need not describe all aspects of the existing system, but it should represent enough of the important elements and their interrelationships to describe the essential nature of the existing system. The mathematical model functions as an artificial or virtual instance of an existing system, where the artificial instance can be manipulated in a manner that mimics or simulates the behavior of the actual existing system. The mathematical models can take the form of symbolic models that represent systems in terms of the way they function, often through time and over space. Symbolic models involve the use of mathematical symbols, letters, numbers and operators (+, −, ×,) to represent relationships among various variables of the system to describe the system's properties or behavior.

The various components/modules/models of the systems illustrated herein are depicted separately for ease of illustration and explanation. In embodiments of the invention, the functions performed by the various components/modules/models can be distributed differently than shown without departing from the scope of the various embodiments of the invention describe herein unless it is specifically stated otherwise.

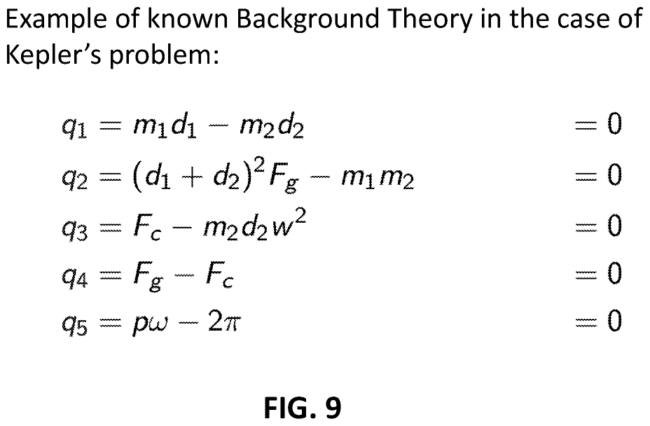

Turning now to an overview of aspects of the invention, embodiments of the invention described herein provide computing systems, computer-implemented methods, and computer program products operable to compose a novel logical & statistical (L&S) model of an existing system or process using novel L&S model composition techniques. In embodiments of the invention, the existing system or process includes a PUA and/or a phenomena under study/consideration. The novel L&S model composition techniques are operable to concurrently perform two complementary forms of inference—namely, logical (e.g., symbolic) inferences and statistical (e.g., numerical) inferences. In some embodiments of the invention, the novel L&S model composition techniques satisfy target data fidelity levels and are compatible with known background theory associated with the existing system. As used in this detailed description, data fidelity is a measure of how well a trained mathematical model makes predictions from new data, particularly where the new data is different from the data that was used to train the mathematical model. Further, as used in this detailed description, background theory is a logical theory that includes any combination of the formulas that are known about the existing system/process under consideration. In turn, the logic theory is a collection of axioms expressed as symbolic relations (defined by a specific logic grammar and logic expressivity—e.g., first-order logic (FOL)). The axioms/theorems can be incorporated together, by formal reasoning steps, called inference steps. The reasoning steps are performed following the rules of a specific inference paradigm (e.g. resolution). A new theorem can be derived from a theory, by virtue of performing several inference steps. Examples of known background theory, in accordance with the above-described definition, include a list of background theory instances (e.g., q₁=m₁d₁−m₂d₂) depicted in FIG. 9 and described in greater detail subsequently herein.

In some embodiments of the invention, the computing systems, computer-implemented methods, and computer program products can be embodied in a novel L&S symbolic model composer operable to implement the novel L&S model composition operations that generates a novel composed L&S model of an existing system. In embodiments of the invention, the novel L&S model composition operations include analyzing numerical data of the existing system, along with known background theory associated with the existing system, in a novel manner that includes representing the functional relationships among the numerical data of the existing system, along with the known background theory of the existing system, within a common, highly expressive mathematical expression domain having properties that facilitate the joint or unitary analysis of numerical data functions and the known background theory as a multi-objective optimization problem that can be solved using known and effective optimization techniques such as setting up the analysis as a semidefinite programming problem that can be solved using a semidefinite programming solver. In embodiments of the invention, the highly expressive mathematical expression domain is the mathematical expression domain of polynomial functions provided as a set of polynomial equalities and inequalities.

In an example operation according to embodiments of the invention, the novel L&S symbolic model composer is operable to compose a novel L&S symbolic mathematical model of an existing system by performing a novel L&S analysis on any combination of data of the existing system; known background theory of the existing system; and user preferences associated with the different identified objectives of the composed L&S model. The novel L&S symbolic model composer formulates a multi-objective optimization problem based on any combination of raw data associated with the existing system; known background theory of the existing system; and the user preferences. In embodiments of the invention, the multiple objectives of the multi-objective optimization problem includes any combination of a measure of fidelity of the composed L&S model to data (i.e., “data fidelity” of the composed L&S model); a measure of fidelity of the composed L&S model to known background theory; and a measure of the complexity of the resulting composed L&S symbolic mathematical model. The multi-objective optimization problem can be optimized in a manner that accounts for noise, inconsistencies, and complexities of the problem.

The measure of fidelity accounts for the inherent noise that might be present in the data. The measure of fidelity accounts for possible inconsistencies, incompleteness, and inexactness of the background theory. The measure of complexity accounts for measures of various nature, including computational complexity, functional complexity, and representational complexity. The background theory is, in some embodiments of the invention, given by a set of polynomial equalities and inequalities.

The system in accordance with aspects of the invention, outputs a symbolic model of minimal complexity that is consistent with provided data and background theory. The system in accordance with aspects of the invention also outputs and easily-verifiable logical certificate that the derived model can indeed be derived from the background theory. To ensure consistency of the symbolic model with the background theory, the optimization problem searches for a polynomial multiplier associated with each polynomial equality and each polynomial inequality. The user can consider different trade-offs between various criteria and select the ones that best suits their specific design preferences (e.g., complexity, accuracy, and consistency with background theory).

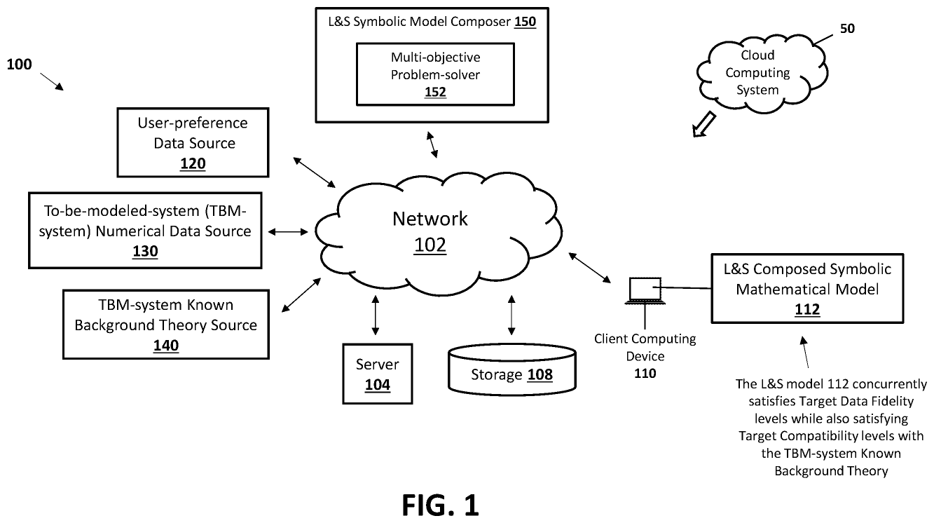

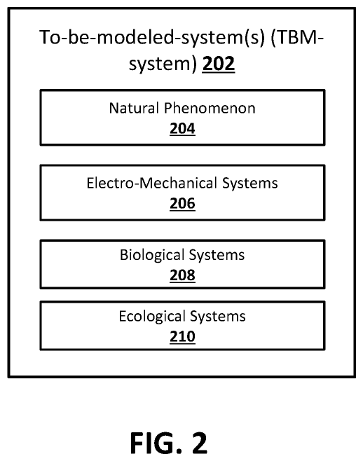

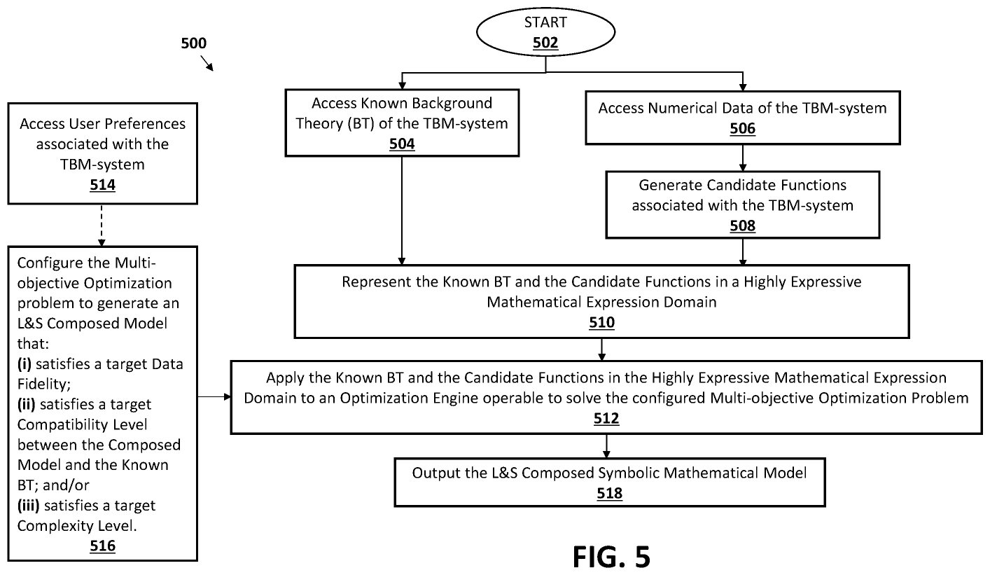

Turning now to a more detailed description of various embodiments of the invention, FIG. 1 depicts a block diagram illustrating a “model composition” (MC) system 100 operable to implement aspects of the invention, including specifically using a novel L&S symbolic model composer 150 to generate a composed L&S symbolic mathematical model 112 of an existing system (e.g., the to-be-modeled-systems (TBM-systems) 202 shown in FIG. 2) that can be incorporated within a client computing device 110 and utilized to perform in silico analysis and research. In accordance with aspects of the invention, the novel L&S symbolic model composer 150 includes a multi-objective problem solver 152 and is operable to utilize any combination of the data/information from the sources 120, 130, 140 to perform a novel and automated L&S model composition process (e.g., the computer-implemented methodology 500 shown in FIG. 5) that generates the composed L&S symbolic mathematical model 112. In accordance with aspects of the invention, the composed L&S symbolic mathematical model 112 is operable to, when executed by the client computing device 110 (i.e., the host device), concurrently satisfy target data fidelity levels while also satisfying target compatibility levels of the composed L&S symbolic mathematical model 112 with known background theory of the existing system. In this detailed description, data fidelity is a measure of how well a trained mathematical model makes predictions from new data, particularly where the new data is different from the data that was used to train the mathematical model. Additionally, in this detailed description, a known background theory associated with an existing system can be described as a logical theory that includes any combination of the formulas known about the existing system/process under consideration. In turn, a logic theory is a collection of axioms expressed as symbolic relations (defined by a specific logic grammar and logic expressivity—e.g., first-order logic (FOL)). The axioms/theorems can be incorporated together, by formal reasoning steps, called inference steps. The reasoning steps are performed following the rules of a specific inference paradigm (e.g. resolution). A new theorem can be derived from a theory, by virtue of performing several inference steps. Examples of known background theory, in accordance with the above-described definition, include a list of background theory instances (e.g., q₁=m₁d₁−m₂d₂) depicted in FIG. 9 and described in greater detail subsequently herein.

The MC system 100 is a non-limiting example of an operating domain of the novel L&S symbolic model composer 150 and the associated composed symbolic mathematical model 112. The MC system 100 depicted in FIG. 1 includes a server 104, a storage element 108, at least one client computing device 110, a user-preference data source 120, a TBM-system data source 130, and a TBM-system known background theory source 140, all of which are in communication with one another through a network 102. A customer or user (now shown) has access to the client computing device 110 for purposes of operating the client computing device 110 in a manner that allows the customer to perform various types of analysis (e.g., in silico research, experiments, studies, and the like) on the composed symbolic mathematical model 112 as a proxy for performing such analysis on an existing system (e.g., the TBM-systems 202 shown in FIG. 2) that the model 112 represents.

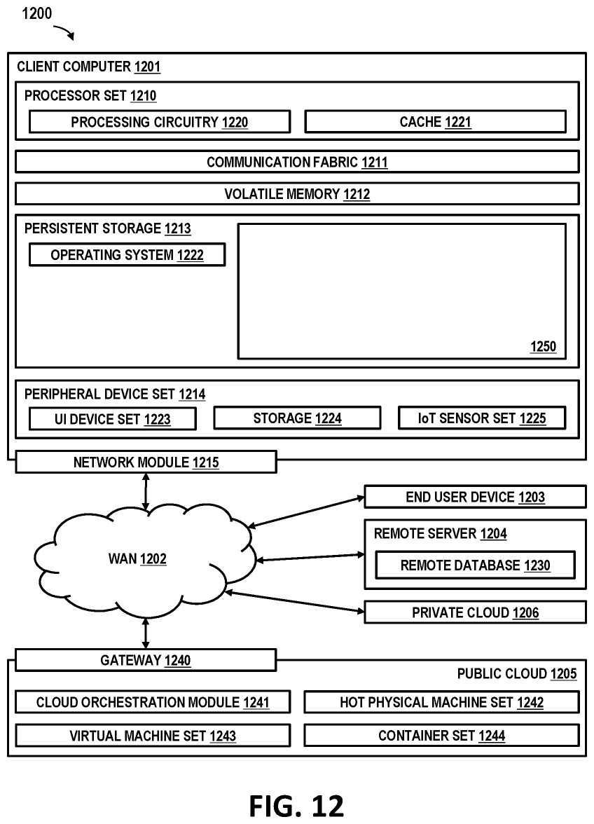

For ease of illustration, one example the server 104, the storage element 108, and the client computing devices 110 is shown. However, it is understood that embodiments of the invention can accommodate multiple instances of the server 140, the storage element 108, and the client computing device 110. In embodiments of the invention, the server 104, the client computing device 110, and the novel L&S symbolic model composer 150 can be configured to include some of all of the features and functionality of the computing system environment 1200 (shown in FIG. 12).

The MC system 100 includes at least one network 102, which is the medium used to provide communication links between various devices and computers connected together within the MC system 100. The network 102 can include connections, such as wire, wireless communication links, or fiber optic cables. The client computing devices 110 can be, for example, personal computers, network computers, or the like. In the depicted example, the server 104 provides data, such as boot files, operating system images, and applications to the client computing device 110. The client computing device 110 is a client to the server 104 in the depicted example. The MC system 100 can include additional servers, client computing devices, and other devices not shown.

In some embodiment of the invention, the network 102 of the MC system 100 can be the internet as represented by a worldwide collection of networks and gateways that use the transmission control protocol/internet protocol (TCP/IP) suite of protocols to communicate with one another. At the heart of the internet is a backbone of high-speed data communication lines between major nodes or host computers, consisting of thousands of commercial, governmental, educational and other computer systems that route data and messages. In some embodiments of the invention, the network 102 of the MC system can also include a number of different types of networks, such as for example, an intranet, a local area network (LAN), a wide area network (WAN), or the like.

In some embodiments of the invention, the server 104 and the storage element 108 can be a general purpose computing device and a general purpose memory, respectively, operable to provide additional support for operations performed at the novel L&S symbolic model composer 150 and/or the client computing device 110. In some embodiments of the invention, the server 104 can manage authentication and authorization of a user's access to the client computing device 110.

A cloud computing system 50 is in wired or wireless electronic communication with the system 100, and in particular with the server 104. The cloud computing system 50 can supplement, support or replace some or all of the functionality (in any combination) of the MC system 100, including specifically the automated and novel L&S symbolic model composer 150. Additionally, some or all of the functionality of the MC system 100, including specifically the automated and novel L&S symbolic model composer 150, can be implemented as a node of the cloud computing system 50. Additional details of cloud computing functionality that can be used in connection with aspects of the invention are depicted by the computing environment 1200 shown in FIG. 12 and described in greater detail subsequently herein.

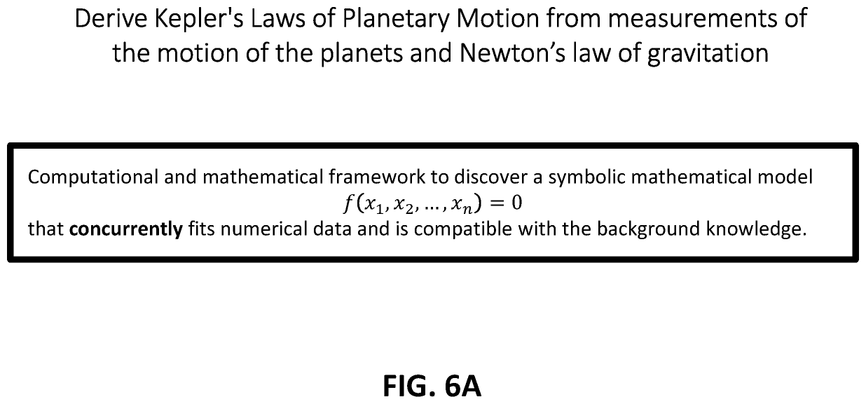

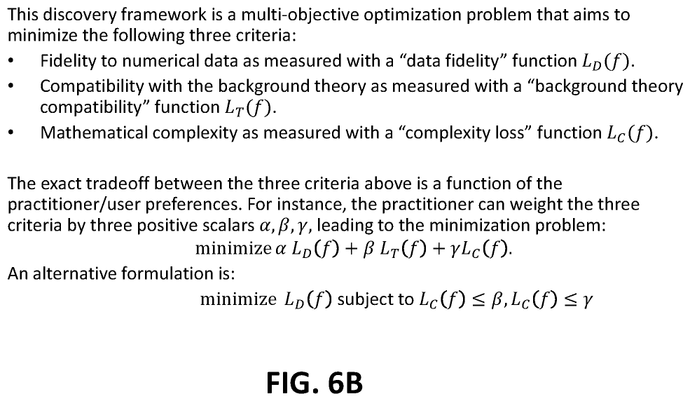

FIG. 2 depicts a block diagram illustrating non-limiting examples of existing systems that can be modeled in accordance with embodiments of the invention. The existing systems are described herein as to-be-modeled-systems (TBM-systems) 202, which can include, for example, natural phenomenon 204, electro-mechanical systems 206, biological systems 208, ecological systems 210, and the like. In embodiments of the invention described herein, the TBM-system 202 is implemented as the solar system that consists of the Sun, and everything bound to it by gravity, namely, the planets Mercury, Venus, Earth, Mars, Jupiter, Saturn, Uranus, and Neptune; dwarf planets such as Pluto; dozens of moons; and millions of asteroids, comets, and meteoroids. More specifically, in the primary example embodiments of the invention described herein (depicted in FIGS. 6-11), the TBM-system 202 is various aspects of Kepler's laws of planetary motion, which were published by Johannes Kepler between 1609 and 1619. In astronomy, Kepler's laws of planetary motion describe the orbits of planets around the Sun. The laws modified the heliocentric theory of Nicolaus Copernicus, replacing its circular orbits and epicycles with elliptical trajectories, and explaining how planetary velocities vary. The three laws state that the orbit of a planet is an ellipse with the Sun at one of the two foci; a line segment joining a planet and the Sun sweeps out equal areas during equal intervals of time; and the square of a planet's orbital period is proportional to the cube of the length of the semi-major axis of its orbit. The elliptical orbits of planets were indicated by calculations of the orbit of Mars. From this, Kepler inferred that other bodies in the solar system, including those farther away from the Sun, also have elliptical orbits. The second law helps to establish that when a planet is closer to the Sun, it travels faster. The third law expresses that the farther a planet is from the Sun, the slower its orbital speed, and vice versa.

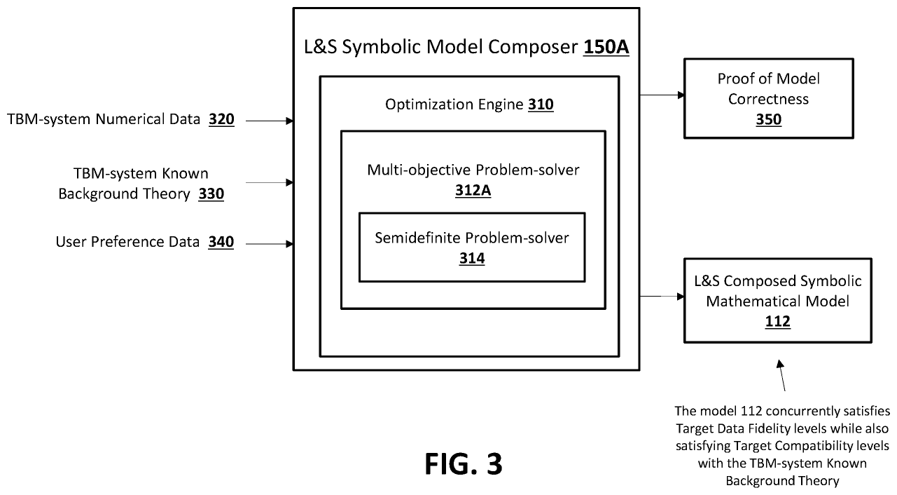

FIG. 3 depicts a block diagram illustrating an example of how the novel L&S symbolic model composer 150 (shown in FIG. 1) having a multi-objective problem-solver 312 (shown in FIG. 1) can be implemented as a novel L&S symbolic model composer 150A having a multi-objective problem-solver 312A in accordance with embodiments of the invention. The novel L&S symbolic model composer 150A receives TBM-system numerical data 320, TBM-system known background theory 330, and user preference data 340 through the network 102 (shown in FIG. 1) from the sources 120, 130, 140 (shown in FIG. 1). The novel L&S symbolic model composer 150A is tasked with composing or identifying a symbolic mathematical model 112 that governs relationships between and among the numerical data 320; that is compatible with or consistent with the TBM-system known background theory 330; satisfies the user preference data 340; and that satisfies various other constraints, including, for example, data fidelity levels and function complexity levels of the composed L&S model 112.

The novel L&S symbolic model composer 150A includes an optimization engine 310 operable to implement the multi-objective problem-solver 312A. The optimization engine 110 is operable to perform a variety of optimization methods or techniques, including, for example, multi-objective optimization techniques. In general optimization methods are designed to determine the best possible solution to a well-defined problem. Optimization methods are used in many areas of study to find solutions that maximize or minimize selected parameters, such as minimizing the amount of raw material used in the development of a product. Any multi-objective optimization problem can be defined as the optimization of several objectives subjected to a number of equality and inequality constraints. In general, multi-objective optimization methods seek to optimize several objective functions, along with selected inequality and equality constraints. The goal is to find a set of solutions that do not have any constraint violation and are as good as possible regarding all its objectives values.

In some embodiments of the invention, the multi-objective problem solver 312 can be implemented as semidefinite problem-solver 314. In general, semidefinite programming (SDP) is a subfield of convex optimization concerned with the optimization of a linear objective function (a user-specified function that the user wants to minimize or maximize) over the intersection of the cone of positive semidefinite matrices with an affine space, i.e., a spectrahedron. For example, in automatic control theory, SDP is used in the context of linear matrix inequalities. SDP is in fact a special case of cone programming and can be efficiently solved by interior point methods. All linear programs and (convex) quadratic programs can be expressed as SDP, and via hierarchies of SDP, the solutions of polynomial optimization problems can be approximated.

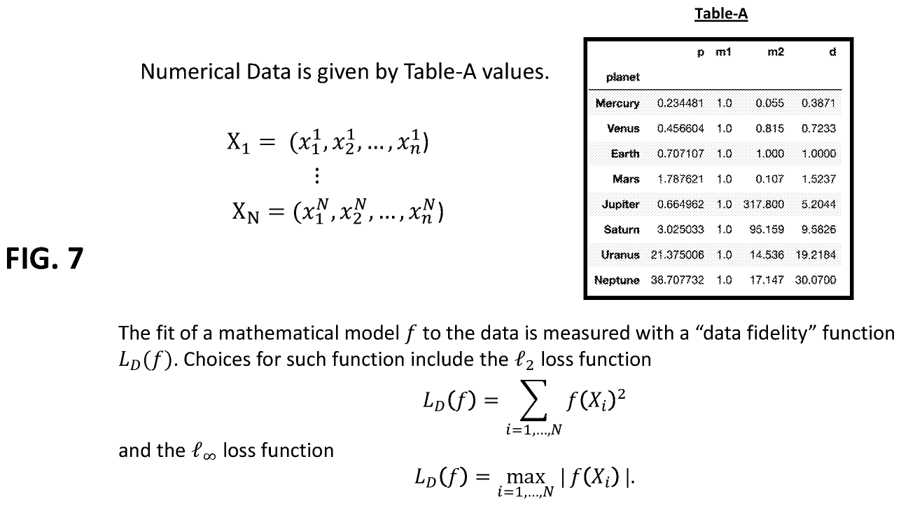

In some embodiments of the invention, the semidefinite problem-solver 314 can be implemented as a semidefinite problem-solver having equalities and inequalities. As an example, the relationship between features represented by variables A1, A2, and A2 can be an unknown function (ƒ). If a candidate function ƒ_{C} is valid, it can be used to determine the variable A1 when the variables A2 and A3 are known. In other words, if we input values for A2 and A3 into ƒ_{C}, will ƒ_{C} return a value for variable A1 that closely matches the actual value of A1, which is represented as true-A1. So the optimization engine 310 is generating instances of ƒ_{C}, and for each instance of ƒ_{C} the optimization engine 310 evaluates how closely the output from ƒ_{C} matches true-A1. In other words, the optimization engine 310 is continuously evaluating candidate functions to determine whether the difference between the A1 value predicted by ƒ_{C} and the value of true-A1. This can be expressed as ƒ(A2, A3)=true-A1, which can be expressed as ƒ(A2, A3)-true-A1=0, which can be expressed as a so-called “equality constraint” by the shorthand notation ƒ(A1, A2)=0. In some embodiments of the invention, the equality constraint can be represented as a more relaxed “inequality constraint” represented by ƒ(A2, A3)≥0. For the analysis performed on the TBM-system numerical data 320 in accordance with aspects of the invention, this difference is the data fidelity associated with a given ƒ_{C}. A suitable loss function (e.g., L_{D}(ƒ) shown in FIG. 7) can be selected or developed, and the loss function can be used to measure the difference between true-A1 and the predicted value of A1 generated by the various candidate functions while the optimization engine 310 is converging toward a solution.

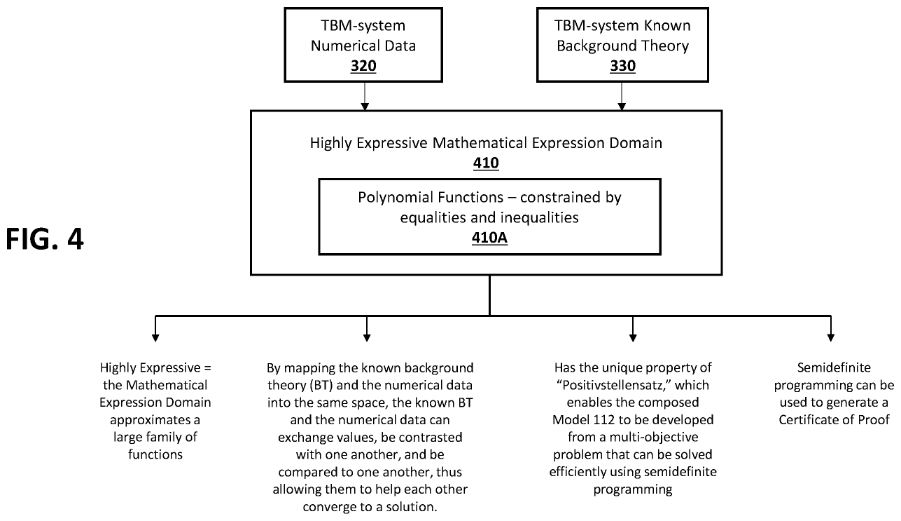

FIG. 4 depicts a block diagram illustrating additional functionality of the novel L&S symbolic model composer 150A shown in FIG. 3. This additional functionality will now be described with reference to the novel L&S symbolic model composer 150A shown in FIG. 3 and a highly expressive mathematical expression domain 410 shown in FIG. 4 that is utilized by the novel L&S symbolic model composer 150A to generate the composed symbolic mathematical model 112 (shown in FIG. 3) and the proof of model correctness 350 (shown in FIG. 3). In embodiments of the invention, the highly expressive mathematical expression domain 410 can be implemented as polynomial functions constrained by equalities and inequalities. For ease of explanation, the functionality of the highly expressive mathematical expression domain 410 will be described in connection with the example highly expressive mathematical domain expression shown in FIG. 4 as the polynomial functions 410A. It should be understood that the features described in FIG. 4 apply to the general category of highly expressive mathematical expression domains 410 having the features and functionality depicted in FIG. 4.

As shown, the polynomial functions 410A are highly expressive, which means they can be used to approximate a large family of functions. In accordance with aspects of the invention, the novel L&S symbolic model composer 150A is operable to map the TBM-system numerical data 320 and the TBM-system known background theory 330 in the same space, namely the polynomial functions 410A, which are constrained by equalities and inequalities. By mapping the numerical data 320 and the known background theory 330 into the same space, the known background theory 330 and the numerical data can 320 exchange values, be contrasted with one another, and be compared to one another, thus allowing them to help each other converge to a solution during analysis by the optimization engine 310. Additionally, there is typically an inverse relationship between the expressiveness of a mathematical expression domain and how easily optimization problems can be solved in the mathematical expression domain. However, polynomial functions are both highly expressive and can be solved using a suite of known problem solving techniques, such as semidefinite programming. Accordingly, in addition to the previously-described technical benefits of mapping the numerical data 320 and the known background theory 330 into the same space prior to performing the optimization engine analyses, polynomial functions constrained by equalities and inequalities provide the additional technical benefit of having an algebraic structure that makes them particularly appealing from a computational point of view. The polynomial functions demonstrate the unique property of “Positivstellensatz” (German for “positive-locus-theorems”) from the field of real algebraic geometry, which states that searching over mathematical models that are derivable from a set of polynomial equalities and inequalities can be turned into a search for so-called “polynomial multipliers.” Such a search can be conducted efficiently via semidefinite programming. Semidefinite programming provides the additional technical benefit of having built in “proof” functionality that generates a so-called certificate of proof for its solutions, which can be used as the proof of model correctness 350 shown in FIG. 3. The compatibility of the composed symbolic mathematical model 112 with the known background theory 330 can be measured with a “background theory fidelity loss function” L_{T}(ƒ). This loss function is zero when ƒ is derivable from the background theory, is small when ƒ is approximately derivable, and is large when ƒ is far from being derivable.

FIG. 5 depicts a flow diagram illustrating a computer-implemented method 500 according to embodiments of the invention. In embodiments of the invention, the methodology 500 is performed by the novel L&S symbolic model composer 150, 150A (shown in FIGS. 1 and 3) using the highly expressive mathematical expression domain 410 and/or the polynomial functions 410A constrained by equalities and inequalities (shown in FIG. 4). The methodology 500 begins at block 502 then moves in parallel to blocks 504, 506. At block 504, the TBM-system known background theory 330 (shown in FIG. 3) are accessed from the source 130 (shown in FIG. 1). At block 506, the TBM-system numerical data 320 (shown in FIG. 3) is accessed from the source 120 (shown in FIG. 1). At block 508, the methodology 500 generates candidate functions (i.e., functions that are candidates to be the composed symbolic mathematical model 112 shown in FIGS. 1 and 3) associated with the TBM-system 504 using the numerical data 320 accessed at block 508. At block 510, the methodology represented the known background theory and the candidate functions in the highly expressive mathematical expression domain 410 and/or the polynomial function domain 410A constrained by equalities and inequalities and having the features and functionality described in FIG. 4.

At block 512, the methodology 500 applies the known background theory and the candidate functions in the highly expressive mathematical expression domain 410, 410A to the optimization engine 310, which is operable to solve a multi-objective optimization problem that has been configured using information developed at block 516 and, optionally, block 514. At block 516, the methodology 500 is operable to configure the multi-objective optimization problem defined at block 512 such that it satisfies a target data fidelity; satisfies a target compatibility level between the composed L&S model 112 and the known background theory 330; and/or satisfies a target complexity level of the composed L&S model 112. In some embodiments of the invention, block 514 can apply user preferences to the configuration operations at block 516 by, for example, applying weights to the target data fidelity; the target compatibility level between the composed L&S model 112 and the known background theory 330; and/or the target complexity level of the composed L&S model 112. At block 518, the solution to the multi-objective optimization problem solved at block 512 is output as the composed L&S model 112.

FIGS. 6-11 depict an example of how embodiments of the invention can be applied where the TBM-system 202 is implemented as the solar system that consists of the Sun, and everything bound to it by gravity, namely, the planets Mercury, Venus, Earth, Mars, Jupiter, Saturn, Uranus, and Neptune; dwarf planets such as Pluto; dozens of moons; and millions of asteroids, comets, and meteoroids. More specifically, in the example embodiments of the invention depicted in FIGS. 6-11, the TBM-system 202 is various aspects of Kepler's laws of planetary motion, which were published by Johannes Kepler between 1609 and 1619. In astronomy, Kepler's laws of planetary motion describe the orbits of planets around the Sun. The laws modified the heliocentric theory of Nicolaus Copernicus, replacing its circular orbits and epicycles with elliptical trajectories, and explaining how planetary velocities vary. The three laws state that the orbit of a planet is an ellipse with the Sun at one of the two foci; a line segment joining a planet and the Sun sweeps out equal areas during equal intervals of time; and the square of a planet's orbital period is proportional to the cube of the length of the semi-major axis of its orbit. The elliptical orbits of planets were indicated by calculations of the orbit of Mars. From this, Kepler inferred that other bodies in the solar system, including those farther away from the Sun, also have elliptical orbits. The second law helps to establish that when a planet is closer to the Sun, it travels faster. The third law expresses that the farther a planet is from the Sun, the slower its orbital speed, and vice versa.

As shown in FIG. 6A, the example task of deriving Kepler's laws of planetary motion from measurements of the motion of the planets and Newton's law of gravitation using a computational and mathematical framework, in accordance with aspects of the invention, to compose an L&S symbolic mathematical model (e.g., L&S model 112 shown in FIG. 1) that concurrently fits numerical data and is compatible with the background theory.

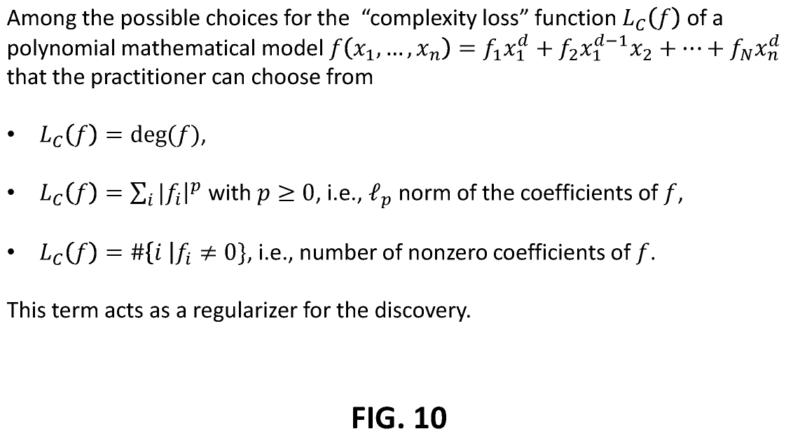

As shown in FIG. 6B, this L&S framework is a multi-objective optimization problem that aims to minimize three criteria, namely, fidelity to numerical data as measured with a “data fidelity” function L_{D}(ƒ); compatibility with the background theory as measured with a “background theory compatibility” function L_{T}(ƒ); and mathematical complexity as measured with a “complexity loss” function L_{C}(ƒ). The exact tradeoff between the three criteria above is a function of the practitioner/user preferences. For instance, the practitioner can weight the three criteria by the three positive scalars shown in FIG. 6B, which leads to the minimization functions shown in FIG. 6B. FIG. 10 depicts examples of the possible choices for the “complexity loss” function L_{C}(ƒ) depicted in FIG. 6B.

FIG. 7 depicts additional detail of the numerical data gathering features. The data comes with numbers for different features (X₁ through X_{N} represent numerical values for different features). A shown in Table-A, if one is looking at a planet, planetary mass can be X₁ and planetary speed can be X₂, and so on. The equation we are looking for as represented in FIG. 6A is written in an abstract way, but what it represents is posing the question, can we find the time it takes for a planet to rotate around the sun in terms of the variables X₁, X₂, . . . . X_{N}. So what we are trying to accomplish with the function (ƒ) is not only should it satisfy the numerical data (i.e., we get a good approximation of the input and the output values using the function), but the function should also be consistent with or compatible with known background theory. There could be many functions that satisfy the data, but only a subset of those functions is consistent with known background theory.

We are looking for a function ƒ that can be used to relate one of the specific features of the existing system to the rest. Referring to Table-A, function ƒ will need to express the period p in terms of m1, m2, and d. In other words, can we derive a function or model that inputs values for m1, m2, and d, and returns the a p value that matches the actual p value closely? So we use optimization operations to try to find this sort of model/function, and for each function we find, we can evaluate how closely we match actual p. To do this we can evaluate the difference between the p value predicted by the function/model and the actual value of p. And this difference can be referred to as data fidelity. The loss functions at the bottom of FIG. 7 can be used to measure the difference between the predicted p and the true p.

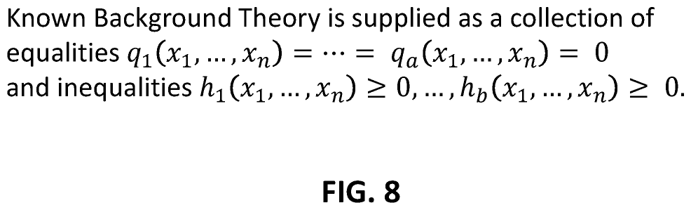

As shown in FIG. 8, the known background theory can be supplied as a collection of equalities and inequalities. On the one hand, polynomial functions are very expressive, in the sense that they can be used to approximate a large family of functions. On the other hand, the algebraic structure behind a highly expressive mathematical expression domain such as polynomial functions makes them particularly appealing from a computational point of view. Polynomial functions display the positive characteristics of “Positivstellensatz” (German for “positive-locus-theorems”) from the field of real algebraic geometry, which states that searching over mathematical models that are derivable from a set of polynomial equalities and inequalities can be turned into a search for so-called “polynomial multipliers.” Such a search can be conducted efficiently via semidefinite programming. Compatibility of a mathematical model ƒ with the background theory above is measured with a “background theory fidelity loss function” L_{T}(ƒ). This loss function is zero when ƒ is derivable from the known background theory, is small when ƒ is approximately derivable, and is large when ƒ is far from being derivable.

FIG. 9 depicts examples of known background theory that can be used in the case of Kepler's problem. In accordance with embodiments of the invention, each background theory is written in terms of equalities such that the right hand side of the equation is zero. So each row or formula shown in FIG. 9 represents a known relationship between the variables used to define the TBM-system, that is accepted as being true, and that was given to us, and that can be represented in a polynomial mathematical expression format, and set as being equal to zero.

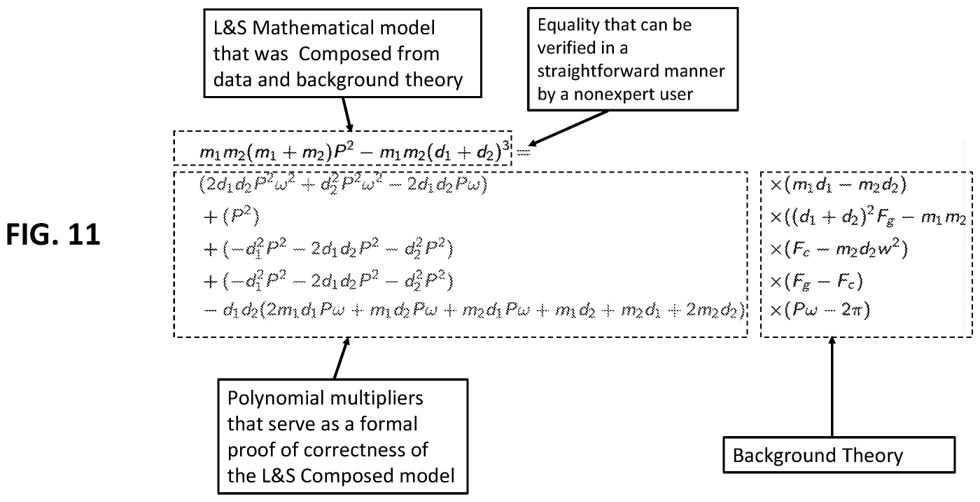

FIG. 11 depicts the results generated from applying the methodology 500 shown in FIGS. 4 and 5 to derive Kepler's laws. The results include a mathematical model that was composed from data and background theory. The equality can be verified in a straightforward manner using polynomial multipliers that serve as a formal proof of correctness of the composed mode.

Thus, it can be seen from the foregoing detailed description that embodiments of the invention provide technical benefits and technical effects by providing a mechanism for composing well-functioning mathematical models of existing systems by effectively composing an L&S model that satisfies both data fidelity targets and target compatibility levels between the composed L&S model and known background theory of the existing system. The mechanism includes placing both the candidate functions and the known background theory in the same mathematical expression domain, which facilitates analyzing target goals for the candidate functions and target goals for the known background theory such that both sets of target goals can be satisfied substantially concurrently, thereby facilitating the generation of the composed L&S model that satisfies a target data fidelity in a manner that also satisfies a predetermined level of compatibility between the composed L&S model and the set of known background theory.

In embodiments of the invention, the mathematical expression domain is selected based at least in part on an expressive capability of the mathematical expression domain; and the expressive capability of the mathematical expression domain includes a breadth of the candidate functions that can be represented in the mathematical expression domain. The above-described features provide technical effects and benefits over known model composition approaches in that selecting the mathematical expression domain based on its expressive capability allows selection of a mathematical expression domain having the ability to approximate a large family of functions, which allows the L&S model composition operations to generate a wide range of composed L&S models.

By selecting the mathematical expression domain to be a polynomial mathematical expression (or a polynomial function) provides the capability of searching over mathematical models that are derivable from a set of polynomial equalities and inequalities can be turned into a search for so-called polynomial multipliers that can advantageously be conducted using semidefinite programming. Additionally, providing the mathematical expression domain as polynomial functions provides the previously-described ability to approximate a large family of functions, which allows the L&S model composition operations to generate a wide range of composed L&S models.

Performing the L&S model composition operations further includes providing the mathematical expression domain as a polynomial mathematical expression (or a polynomial function) and analyzing, in the polynomial function domain, the set of candidate functions and the set of known background theory to generate a proof of correctness of the composed L&S model, thereby proving technical effects and benefits in that, as a general proposition, the more expressive a model or function is, the more difficult it will be to prove the theorems contained in the model or function, and to solve optimization problems in the model or function. The use of polynomial functions with equalities, or with inequalities, provides an extremely expressive mathematical domain for conducting the L&S model composition operations using efficient techniques (e.g., semidefinite problem-solving techniques) that efficiently work with polynomial functions while also offering functionality that generates a proof of correctness of the resulting composed L&S model.

Analyzing, in the mathematical expression domain, the set of candidate functions and the set of known background theory to generate the composed L&S model such that the composed L&S model satisfies the target data fidelity in a manner that also satisfies a target complexity level of the composed L&S model provides technical effects and benefits in that the target complexity level can be selected such that the complexity of the composed L&S model is minimized, thereby improving efficiency of the model composition operation.

In some embodiments of the invention, performing the L&S model composition operations further includes analyzing, in the mathematical expression domain, the set of candidate functions and the set of known background theory to generate the composed L&S model in a manner that applies a first weighted user preference to the target data fidelity; a second weighted user preference to the predetermined level of compatibility between the composed L&S model and the set of known background theory; and a target complexity level of the composed L&S model. The above-described features provide technical effects and benefits in that the L&S model composition operations can be performed in a manner that allows a user to tailor the L&S model composition operations to provide more or less emphasis on the target data fidelity; the predetermined level of compatibility between the composed L&S model and the set of known background theory; and the target complexity level of the composed L&S model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 12 depicts an example computing environment 1200 that can be used to implement aspects of the invention. Computing environment 1200 contains an example of an environment for the execution of at least some of the computer code involved in performing the inventive methods, such as the automated composition of a novel logical & statistical (L&S) model of an existing system/process using novel L&S model development techniques 1250. In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid state storage devices. Operating system 1222 may take several forms, such as various known proprietary operating systems or open source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The phrases “in signal communication,” “in communication with,” “communicatively coupled to,” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A programmable computer comprising a processor system operable to perform processor system operations comprising:
representing a set of candidate functions in a mathematical expression domain, wherein the set of candidate functions define relationships between data of an existing system;
representing a set of known background theory in the mathematical expression domain, wherein the set of known background theory define known relationships associated with the existing system; and
performing a model composition operation comprising analyzing, in the mathematical expression domain, the set of candidate functions and the set of known background theory to generate a composed model that satisfies a target data fidelity in a manner that also satisfies a predetermined level of compatibility between the composed model and the set of known background theory.

2. The programmable computer of claim 1, wherein the mathematical expression domain is selected based at least in part on an expressive capability of the mathematical expression domain.

3. The programmable computer of claim 2, wherein the expressive capability of the mathematical expression domain comprises a breadth of the candidate functions that can be represented in the mathematical expression domain.

4. The programmable computer of claim 3, wherein the mathematical expression domain comprises a polynomial mathematical expression.

5. The programmable computer of claim 1, wherein performing the model composition operation further comprises analyzing, in the mathematical expression domain, the set of candidate functions and the set of known background theory to generate a proof of correctness of the composed model.

6. The programmable computer of claim 1, wherein performing the model composition operation further comprises analyzing, in the mathematical expression domain, the set of candidate functions and the set of known background theory to generate a derivability measure of the composed model.

7. The programmable computer of claim 1, wherein performing the model composition operation further comprises analyzing, in the mathematical expression domain, the set of candidate functions and the set of known background theory to generate the composed model such that the composed model satisfies the target data fidelity in a manner that also satisfies a target complexity level of the composed model.

8. The programmable computer of claim 1, wherein performing the model composition operation comprises using an optimization engine of the processor system to execute a set of multi-objective optimization operations.

9. The programmable computer of claim 8, wherein the set of multi-objective optimization operations comprises a semidefinite problem-solving technique.

10. A computer-implemented method operable to use a processor system to perform processor system operations comprising:
representing a set of candidate functions in a mathematical expression domain, wherein the set of candidate functions define relationships between data of an existing system;
representing a set of known background theory in the mathematical expression domain, wherein the set of known background theory define known relationships associated with the Existing system; and
performing a model composition operation comprising analyzing, in the mathematical expression domain, the set of candidate functions and the set of known background theory to generate a composed model that satisfies a target data fidelity in a manner that also satisfies a predetermined level of compatibility between the composed model and the set of known background theory.

11. The computer-implemented method of claim 10, wherein:
the mathematical expression domain is selected based at least in part on an expressive capability of the mathematical expression domain; and
the expressive capability of the mathematical expression domain comprises a breadth of the candidate functions that can be represented in the mathematical expression domain.

12. The computer-implemented method of claim 11, wherein the mathematical expression domain comprises a polynomial mathematical expression.

13. The computer-implemented method of claim 10, wherein performing the model composition operation further comprises analyzing, in the mathematical expression domain, the set of candidate functions and the set of known background theory to generate a proof of correctness of the composed model.

14. The computer-implemented method of claim 10, wherein performing the model composition operation further comprises analyzing, in the mathematical expression domain, the set of candidate functions and the set of known background theory to generate the composed model such that the composed model satisfies the target data fidelity in a manner that also satisfies a target complexity level of the composed model.

15. The computer-implemented method of claim 10, wherein performing the model composition operation comprises using an optimization engine of the processor system to execute a set of multi-objective optimization operations comprising a semidefinite problem-solving technique.

16. A computer program product comprising a computer readable program stored on a computer readable storage medium, wherein the computer readable program, when executed on a processor system, causes the processor system to perform processor operations comprising:
representing a set of candidate functions in a mathematical expression domain, wherein the set of candidate functions define relationships between data of an existing system;
representing a set of known background theory in the mathematical expression domain, wherein the set of known background theory define known relationships associated with the Existing system; and
performing a model composition operation comprising analyzing, in the mathematical expression domain, the set of candidate functions and the set of known background theory to generate a composed model that satisfies a target data fidelity in a manner that also satisfies a predetermined level of compatibility between the composed model and the set of known background theory.

17. The computer program product of claim 16, wherein:
the mathematical expression domain is selected based at least in part on an expressive capability of the mathematical expression domain; and
the expressive capability of the mathematical expression domain comprises a breadth of the candidate functions that can be represented in the mathematical expression domain.

18. The computer program product of claim 17, wherein the mathematical expression domain comprises a polynomial mathematical expression.

19. The computer program product of claim 16, wherein performing the model composition operation further comprises analyzing, in the mathematical expression domain, the set of candidate functions and the set of known background theory to generate a proof of correctness of the composed model.

20. The computer program product of claim 16, wherein performing the model composition operation further comprises analyzing, in the mathematical expression domain, the set of candidate functions and the set of known background theory to generate the composed model such that the composed model satisfies the target data fidelity in a manner that also satisfies a target complexity level of the composed model.

21. The computer program product of claim 16, wherein performing the model composition operation comprises using an optimization engine of the processor system to execute a set of multi-objective optimization operations comprising a semidefinite problem-solving technique.

22. A programmable computer comprising a processor system operable to perform processor system operations comprising:
representing a set of candidate functions in a mathematical expression domain, wherein the set of candidate functions define relationships between data of an existing system;
representing a set of known background theory in the mathematical expression domain, wherein the set of known background theory define known relationships associated with the Existing system; and
performing a model composition operation comprising analyzing, in the mathematical expression domain, the set of candidate functions and the set of known background theory to generate a composed model that satisfies a target data fidelity in a manner that also satisfies:
a predetermined level of compatibility between the composed model and the set of known background theory; and
a target complexity level of the composed model;
wherein the mathematical expression domain is selected based at least in part on an expressive capability of the mathematical expression domain that comprises a breadth of the candidate functions that can be represented in the mathematical expression domain;
wherein the mathematical expression domain comprises a polynomial mathematical expression;
wherein performing the model composition operation further comprises analyzing, in the mathematical expression domain, the set of candidate functions and the set of background theory to generate the composed model in a manner that applies:
a first weighted user preference to the target data fidelity;
a second weighted user preference to the predetermined level of compatibility between the composed model and the set of known background theory; and
a target complexity level of the composed model.

23. The programmable computer of claim 22, wherein:
performing the model composition operation comprises using an optimization engine of the processor system to execute a set of multi-objective optimization operations; and
the set of multi-objective optimization operations comprises a semidefinite problem-solving technique.

24. A computer program product comprising a computer readable program stored on a computer readable storage medium, wherein the computer readable program, when executed on a processor system, causes the processor system to perform processor operations comprising:
representing a set of candidate functions in a mathematical expression domain, wherein the set of candidate functions define relationships between data of an existing system;
representing a set of known background theory in the mathematical expression domain, wherein the set of known background theory define known relationships associated with the Existing system; and
performing a model composition operation comprising analyzing, in the mathematical expression domain, the set of candidate functions and the set of known background theory to generate a composed model that satisfies a target data fidelity in a manner that also satisfies:
a predetermined level of compatibility between the composed model and the set of known background theory; and
a target complexity level of the composed model;
wherein the mathematical expression domain is selected based at least in part on an expressive capability of the mathematical expression domain that comprises a breadth of the candidate functions that can be represented in the mathematical expression domain;
wherein the mathematical expression domain comprises a polynomial mathematical expression; and
wherein performing the model composition operation further comprises analyzing, in the mathematical expression domain, the set of candidate functions and the set of background theory to generate the composed model in a manner that applies:
a first weighted user preference to the target data fidelity;
a second weighted user preference to the predetermined level of compatibility between the composed model and the set of known background theory; and
a target complexity level of the composed model.

25. The computer program product of claim 24, wherein:
performing the model composition operation comprises using an optimization engine of the processor system to execute a set of multi-objective optimization operations; and
the set of multi-objective optimization operations comprises a semidefinite problem-solving technique.
